(19) United States
(12) Patent Application Publication
(10) Pub. No.: US 2012/0014541 A1
(43) Pub. Date: Jan. 19, 2012

(54) AMPLIFYING DEVICE FOR CONDENSER MICROPHONE

(76) Inventors: Kazuya Nakayama, Kyoto (JP); Shigeo Masai, Osaka (JP)

(21) Appl. No.: 13/129,702

(22) PCT Filed: Sep. 3, 2010
(86) PCT No.: PCT/JP2010/005429

§ 371 Date: May 17, 2011

(30) Foreign Application Priority Data
Apr. 23, 2010 (JP) 2010-099774

(51) Int. Cl. H04R 3/00

(52) U.S. Cl. 381/111

(57) ABSTRACT

An amplifying device for a condenser-microphone according to the present invention includes: a differential amplifier (20) having an inverting input terminal (1) to which a sound pressure signal output from a condenser microphone (21) is input and a non-inverting input terminal (2) to which a dc bias voltage is applied; a capacitor (24) connected between an output terminal (3) of the differential amplifier (20) and the inverting input terminal (1) of the differential amplifier (20); a resistive element (23) connected, in parallel with the capacitor (24), between the output terminal (3) of the differential amplifier (20) and the inverting input terminal (1) of the differential amplifier (20); and an ESD protecting element (25) having bidirectional diode characteristics, the ESD protecting element (25) being connected, in parallel with the capacitor (24), between the output terminal (3) of the differential amplifier (20) and the inverting input terminal (1) of the differential amplifier (20).

### TECHNICAL FIELD

The present invention relates to amplifying devices for condenser microphones and more particularly relates to condenser-microphone amplifying devices with ESD (electrostatic discharge) protection functions.

### BACKGROUND ART

Capacitive signal sources such as sound pressure sensors have been known as signal sources having high internal impedances. Condenser microphones have been known as a typical example of the sound pressure sensor which is a capacitive signal source. A condenser microphone is configured such that with a diaphragm and an electrode arranged face to face with each other, an external voltage is applied to the electrode to charge it. Because of this configuration, displacement of the diaphragm causes a change in electrostatic capacitance between the diaphragm and the electrode, thereby consequently causing a change in electric potential between the diaphragm and the electrode. By taking out such an electric potential change as an electric signal, the condenser microphone converts sound (sound pressure) into electric signals.

As a conventional amplifying device for such a condenser microphone, there is known an amplifying device as set forth, for example, in Patent Literature 1. FIG. 10 is a circuit diagram illustrating the configuration of this conventional amplifying device. In the amplifying device, an input signal from a condenser microphone 100 is applied to an inverting input terminal of an operational amplifier 101 while a direct current bias voltage from a direct current bias source 107 is applied to a non-inverting input terminal of the operational amplifier 101, as shown in FIG. 10. And a capacitor 103 and a resistor 104 are connected in parallel with each other between the non-inverting input terminal of the operational amplifier 101 and an output terminal 102 of the operational amplifier 101. Patent Literature 1 sets forth that this configuration makes it possible to amplify input signals from the condenser microphone 100 without the influence of a parasitic capacitance 106. In addition, reference numeral 105 denotes a microphone bias source.

### Citation List

### Patent Literature

Patent Literature 1: JP-A-2008-028879

### SUMMARY OF INVENTION

### Technical Problem

Incidentally, electret condenser microphones (ECMs) often finds application in small portable equipment such as portable phones. ECMs are a type of condenser microphone that uses, as a condenser-microphone electrode, an electret produced by causing semi-permanent polarization in the inside of a dielectric substance such as a high polymer material so that electric charges are held in the surface thereof, thereby eliminating the need for the external application of voltage.

The sensitivity and the characteristic of an ECM depend on the electrostatic capacitance between its diaphragm and electrode, and the output of the ECM is in proportion to the amplitude of the diaphragm. The electrostatic capacitance of the ECM depends on the size of the diaphragm, the size of the electrode and the structure therebetween, and is generally from several pF to several tens of pF. In addition, as the load resistance becomes greater, the frequency characteristic becomes flat from lower frequencies. Therefore, in order that the frequency characteristic may be flattened in a voice band (20 Hz to 20 kHz), it is required that the load resistance is set so as to have an extremely large value. Therefore, either an field effect transistor or an operational amplifier having an extremely high input impedance is used as the load resistance of the ECM. On the other hand, if the input impedance is too high, this produces the problem of causing a delay in the response time taken to return to a desired DC operating voltage after power-on to the ECM or after sensing of loud sound. Therefore, generally, the input impedance is set so as to range from several GΩ to several tens of GΩ.

Therefore, it is conceivable that if a conventional amplifying device (for example, as shown in FIG. 10) is used as the load resistance of the ECM, the frequency characteristic becomes flat up to the sound band because of the high input impedance of the operational amplifier and in addition, it is conceivable that if the input impedance is set at from several GΩ to several tens of GΩ, the response time after power-on to the ECM or after sensing of loud sound is expedited to thereby achieve desired electric characteristics. That is, it can be said that amplifying devices configured in conventional ways satisfy desired electric characteristics required for ECMs.

However, there are cases where ESD (Electrostatic Discharge) may occur not only in the process of assembling an ECM amplifying device, but also in the process of assembling a condenser-microphone amplifying device, and countermeasures thereagainst are required to be made accordingly. Nevertheless, in the case where ESD occurs to the inverting input terminal 1 in the amplifying device configured in the conventional way, there is only one current route out to the output terminal 102 of the operational amplifier 101 through the resistor 104, as a route by way of which such static electricity is allowed to escape. Due to this, a high voltage is applied to the resistor 104 if electrostatic discharge momentarily occurs. If this high voltage goes beyond the withstand voltage of the resistor 104, the withstand voltage of the capacitor 103 or the withstand voltage (gate withstand voltage) of an input transistor (for example, a MOS transistor) of the operational amplifier 101, these elements will be destructed.

On the other hand, if an ESD protecting element such as a diode is connected between the inverting input terminal and the grounding terminal or between the inverting input terminal and the power supply terminal in order that ESD destruction may be prevented, this causes the input impedance of the amplifying device to decrease. If the input impedance decreases, this deteriorates the characteristic of the amplifying device. Because of this, elements that cause the input impedance to decrease, such as ESD protecting elements, cannot be connected between the inverting input terminal, and the grounding terminal or the power supply terminal.

If no ESD protecting element is disposed, the inverting input terminal becomes extremely low in ESD tolerance. As a result, in the case where an ECM is connected to the inverting input terminal so as to be faulted as an ECM module, although there is no exposure to outside the module, not only special handling but also special production control is required in order to take extra care of ESD destruction during its manufacture process, thereby making the manufacture method extremely complicated.

It should be noted that, as described above, this problem is not only the problem with ECM amplifying devices, but also the problem in common with condenser-microphone amplifying devices.

The present invention was devised with a view to providing solutions to the above-described problems with the prior art. Accordingly, an object of the present invention is to provide such a condenser-microphone amplifying device that the input impedance can be set at from several GΩ to several tens of GΩ and in addition, the ESD tolerance is improved.

### Solution to Problem

In order to solve the above-described problems, the present invention provides an amplifying device for a condenser microphone. This condenser-microphone amplifying device comprises: a differential amplifier having an inverting input terminal to which a sound pressure signal output from the condenser microphone is input and a non-inverting input terminal to which a dc bias voltage is applied; a condenser connected between an output terminal of the differential amplifier and the inverting input terminal of the differential amplifier; a resistive element connected, in parallel with the condenser, between the output terminal of the differential amplifier and the inverting input terminal of the differential amplifier; and an ESD protecting element having bidirectional diode characteristics, the ESD protecting element being connected, in parallel with the condenser, between the output terminal of the differential amplifier and the inverting input terminal of the differential amplifier.

In accordance with this configuration, the input impedance can be set at from several GΩ to several tens of GΩ and in addition, the ESD tolerance can be improved. As a result, neither special handling nor special control is required in the manufacture procedure, thereby achieving reduction in manufacture lead time and in addition, making it possible to intend to cut down the costs.

The ESD protecting element may be constituted by a pair of diodes which are connected so as to be opposite with each other in a conduction direction of ON-current.

The ESD protecting element may be constituted by a pair of MOS transistors which are each diode-connected and which are connected so as to be opposite with each other in a conduction direction of ON-current.

The ESD protecting element is constituted by a pair of bipolar transistors which are each diode-connected and which are connected so as to be opposite with each other in a conduction direction of ON-current.

The differential amplifier may be an operational amplifier.

The differential amplifier may be configured using a MOS transistor as an amplifying element.

The condenser microphone may be an electret condenser microphone.

This configuration eliminates the need for the external application of voltage and therefore finds application in small portable equipment such as portable phones or the like.

The condenser microphone may be an MEMS microphone.

In accordance with this configuration, as the electrode, there is used an electret which holds surface electric charges produced by semi-permanent polarization whereby the need for the external application of voltage is made unnecessary, thereby finding application in small portable equipment such as portable phones and so on. In addition, it is possible to prepare electrets using inorganic materials, thereby accomplishing excellent resistance to heat and making it possible to perform reflow mounting. Furthermore, when compared to ECM, the number of components can be reduced, thereby making it possible to cut down the costs.

The above and further objects and features of the invention will more fully be apparent from the following detailed description with reference to accompanying drawings.

### Advantageous Effects of Invention

The present invention is configured as described above which provides advantageous effects that the input impedance can be set at from several GΩ to several tens of GΩ, and that the ESD tolerance is improved in the condenser-microphone amplifying device.

### BRIEF DESCRIPTION OF DRAWINGS

FIG. 1 is a circuit diagram showing the configuration of a condenser-microphone amplifying device according to a first embodiment of the present invention.

FIG. 2 is a graph showing the diode characteristic that the ESD protecting element of the condenser-microphone amplifying device of FIG. 1 exhibits.

FIG. 3 is a circuit diagram showing an example of the configuration of the ESD protecting element in the condenser-microphone amplifying device of FIG. 1.

FIG. 4 is a circuit diagram showing an example of the configuration of an operational amplifier in the condenser-microphone amplifying device of FIG. 1.

FIG. 5 is a diagram showing a current emission route in the case where electrostatic discharge occurs to the inverting input terminal of the operational amplifier.

FIG. 6 is a diagram showing a current emission route in the case where electrostatic discharge occurs to the inverting input terminal of the operational amplifier.

FIG. 7 is a circuit diagram showing the configuration of a condenser-microphone amplifying device according to a second embodiment of the present invention.

FIG. 8 is a circuit diagram showing the configuration of a condenser-microphone amplifying device according to a third embodiment of the present invention.

FIG. 9 is a circuit diagram showing the configuration of a condenser-microphone amplifying device according to a fourth embodiment of the present invention.

FIG. 10 is a circuit diagram showing the configuration of a conventional condenser-microphone amplifying device.

### DESCRIPTION OF EMBODIMENTS

Hereinafter, preferred embodiments of the present invention will be described with reference to the drawings. Throughout the drawings, the same or corresponding constituents are designated by the same reference signs and will not be described repetitively.

### First Embodiment

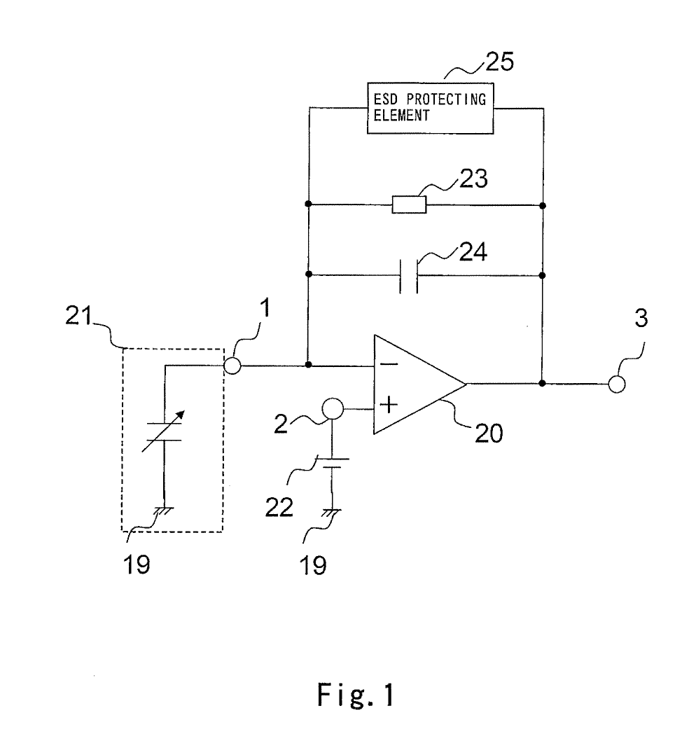

FIG. 1 is a circuit diagram showing the configuration of a condenser-microphone amplifying device according to a first embodiment of the present invention.

### Configuration

As shown in FIG. 1, the condenser-microphone amplifying device of the first embodiment is provided with a differential amplifier 20 as an amplifying element. The differential amplifier 20 is constituted, for example, by an operational amplifier. The following description will be given taking, by way of example, the case where the differential amplifier 20 is constituted by an operational amplifier. An inverting input terminal 1 of the operational amplifier 20 is connected to a condenser microphone 21. The condenser microphone 21 is constituted, for example, by an ECM, an MEMS microphone, a commonly-used condenser microphone or other like microphone. Hereinafter, the description will be given taking, by way of example, the case where the condenser microphone 21 is constituted by an ECM. A sound pressure signal (voltage signal) output from the ECM 21 is input (applied) to the inverting input terminal 1 of the operational amplifier 20. A non-inverting input terminal 2 of the operational amplifier 20 is connected to a dc bias power supply 22 and a dc bias voltage is applied by the dc bias power supply 22 to the non-inverting input terminal 2. A capacitor 24, a resistive element 23 and an ESD protecting element 25 are connected in parallel with each other between an output terminal 3 of the operational amplifier 20 and the inverting input terminal 1 of the operational amplifier 20. The ESD protecting element 25 is configured so as to have bidirectional diode characteristics.

The response time taken to return to a desired dc voltage after power-on is suitably chosen so that the input impedance of the condenser-microphone amplifying device is set at from several GΩ to several tens of GΩ and thereby the frequency characteristic is flattened in a sound signal band (from 20 Hz to 20 kHz).

### Configuration of ESD Protecting Element

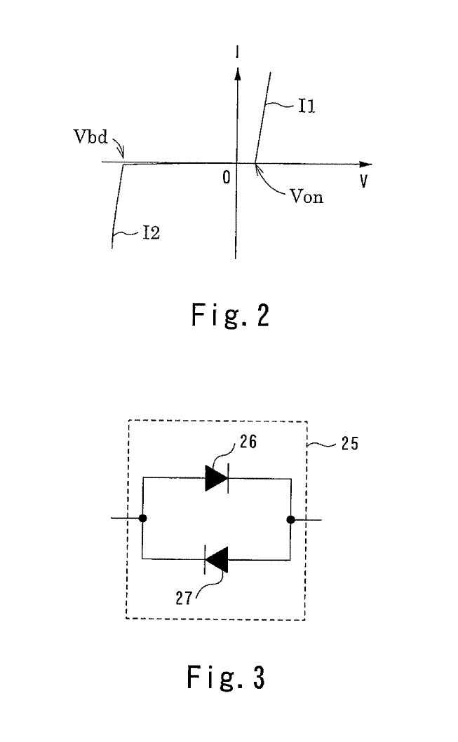

FIG. 2 is a graph showing diode characteristics that the ESD protecting element of the condenser-microphone amplifying device of FIG. 1 exhibits. Referring to FIG. 2, the horizontal axis represents the voltage (bias voltage) V applied between the anode and the cathode of a diode, and the vertical axis represents the current I flowing in the diode. According to the voltage (V)-current (I) characteristic, as the forward voltage (the voltage at which the anode becomes positive on the basis of the cathode) increases, the current I (a forward current I1) varies such that the forward current I1 flows little before the forward voltage V changes to an on voltage Von, but the forward current I1 abruptly increases once the forward voltage V changes to the on voltage Von. On the other hand, as the backward voltage (the voltage at which the anode becomes negative on the basis of the cathode) increases (as the absolute value increases), the current I (a backward current I2) varies such that the backward current I2 flows little before the backward voltage V changes to a breakdown voltage Vbd, but the backward current I2 abruptly increases once the backward voltage V changes to the breakdown voltage Vbd. This diode V-I characteristic has been well known as the so-called “diode characteristic”. In other words, the “diode characteristic” is as follows. That is, both in the region (forward direction) where the forward voltage is applied and in the region (backward direction) where the backward voltage is applied, as the absolute value of the applied voltage V increases, the absolute value of the current I varies such that the current I flows little before the absolute value of the voltage V changes to the absolute value of a specific voltage (either the on voltage Von or the breakdown voltage Vbd, which is hereinafter referred to as the “conducting voltage”) while on the other hand the current I abruptly increases once the absolute value of the voltage V changes to the absolute value of the conducting voltage. The “bi-directional diode characteristic” that the ESD protecting element 25 should exhibit in the present invention means such a V-I characteristic that in each of the two conducting directions of the ESD protecting element 25, as the absolute value of the applied voltage V increases, the absolute value of the current I varies such that like the aforesaid “diode characteristic”, the current I flows little before the absolute value of the voltage V changes to the absolute value of a specific voltage (either the on voltage Von or the breakdown voltage Vbd) while on the other hand the current I abruptly increases once the absolute value of the voltage V changes to the absolute value of the conducting voltage. Note that such an abruptly varied current may be called an “ON-current” in some cases.

Next, a description will be given in regard to the characteristics required for the ESD protecting element 25 in view of the configuration of the microphone amplifying device.

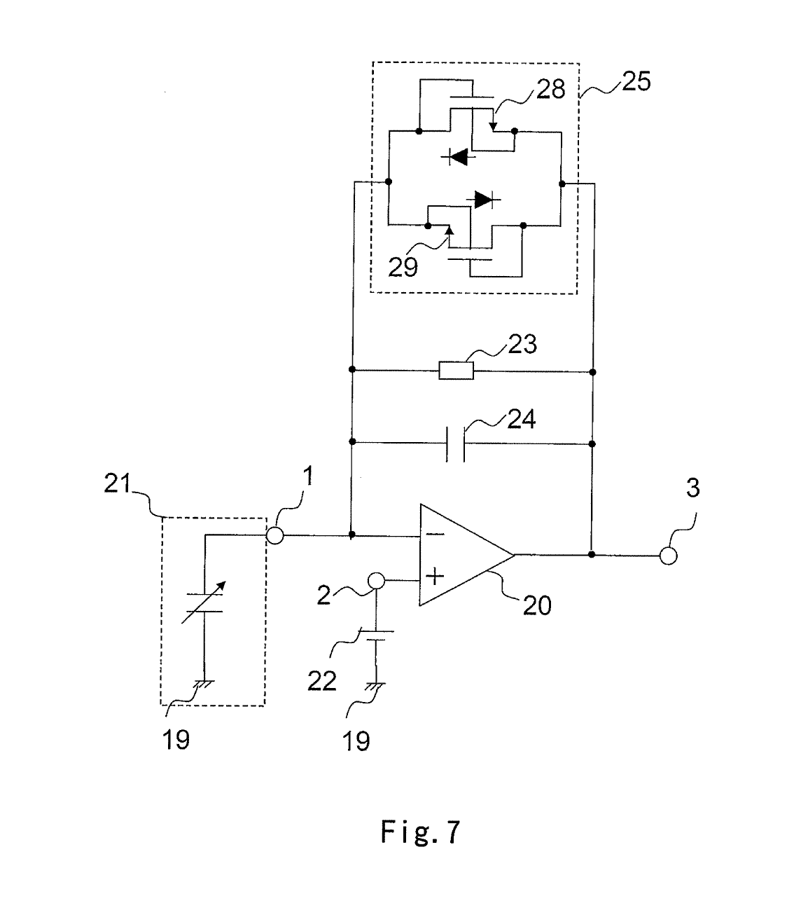

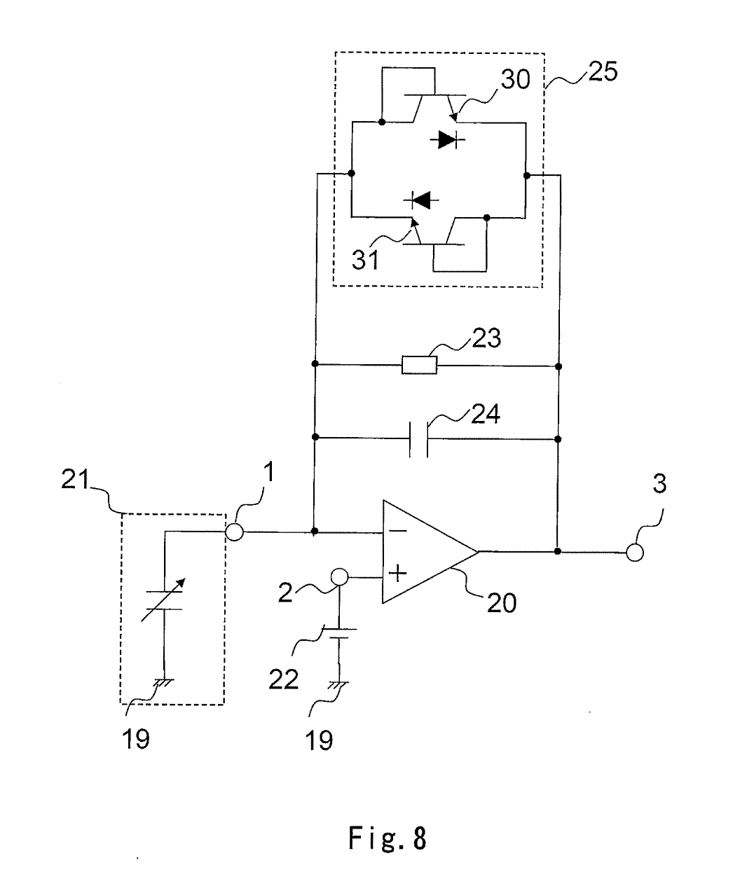

Referring to FIG. 1, the conducting voltage (the on voltage Von or the breakdown voltage Vbd) is required to be less than each of the withstand voltages of the resistive element 23, the capacitor 24 and the input parts of the operational amplifier 20 (generally, the gates of transistors, e.g., the gates of N-channel MOS transistors 4 and 5 in FIG. 3). In addition, it is further required that in normal operation, the aforesaid conducting voltage be greater than the maximum value of the difference in voltage between the inverting input terminal 1 and the output terminal 3 of the operational amplifier 20. Because of this, the ESD protecting element does not become conductive when the operational amplifier 20 is performing normal operations (amplification) and therefore, the operational amplifier 20 is not inhibited from performing normal operations. On the other hand, when a surge is applied to the inverting input terminal 1, the ESD protecting element becomes conductive before the resistive element 23, the capacitor 24 and the input parts of the operational amplifier 20 are destructed, thereby preventing them from being broken down. In addition, the on voltage Von is generally about 0.7 volts and the breakdown voltage Vbd is generally several tens of volts. Examples of the concrete configuration of the ESD protecting element 25 having the “bidirectional diode characteristic” are shown in FIG. 3, in the following second embodiment (FIG. 7) and in the following third embodiment (FIG. 8), respectively. In addition, other than these examples, a zener diode or an MSM (metal-semiconductor-metal) diode can be used as the ESD protecting element 25. Since these elements are bidirectionally conductible, they alone can form the ESD protecting element 25. In addition, the zener diode has the same characteristic as that of the normal diode shown in FIG. 2, and the conducting voltage in the forward direction is the on voltage Von while the conducting voltage in the backward direction is the breakdown voltage Vbd. Besides, the MSM diode is equivalent to Schottky diodes formed back-to-back and the conducting voltage in the forward direction and the conducting voltage in the backward direction correspond to the breakdown voltage at the Schottky junction. Therefore, these elements can be used as the ESD protecting element 25.

FIG. 3 is a circuit diagram showing an example of the configuration of the ESD protecting element 25 in the condenser-microphone amplifying device of FIG. 1. As shown in FIG. 3, the ESD protecting element 25 is constituted, for example, by a pair of diodes 26 and 27 which are connected so as to be opposite with each other in the flow direction of forward current (ON-current). That is, the ESD protecting element 25 is constituted by the diodes 26 and 27 in pair wherein the anode of the one diode 26 and the cathode of the other diode 27 are connected, and the cathode of the one diode 26 and the anode of the other diode 27 are connected. As a result of such a configuration, in both of the two conduction directions of the ESD protecting element 25, the forward voltage region of the aforesaid “diode characteristic” is used, and the ESD protecting element 25 becomes conductive in any of the two conduction directions at the on voltage Von (about 0.7 volts). This preferably prevents the resistive element 23, the capacitor 24 and the input parts of the operational amplifier 20 from undergoing destruction.

### Example Configuration of Operational Amplifier

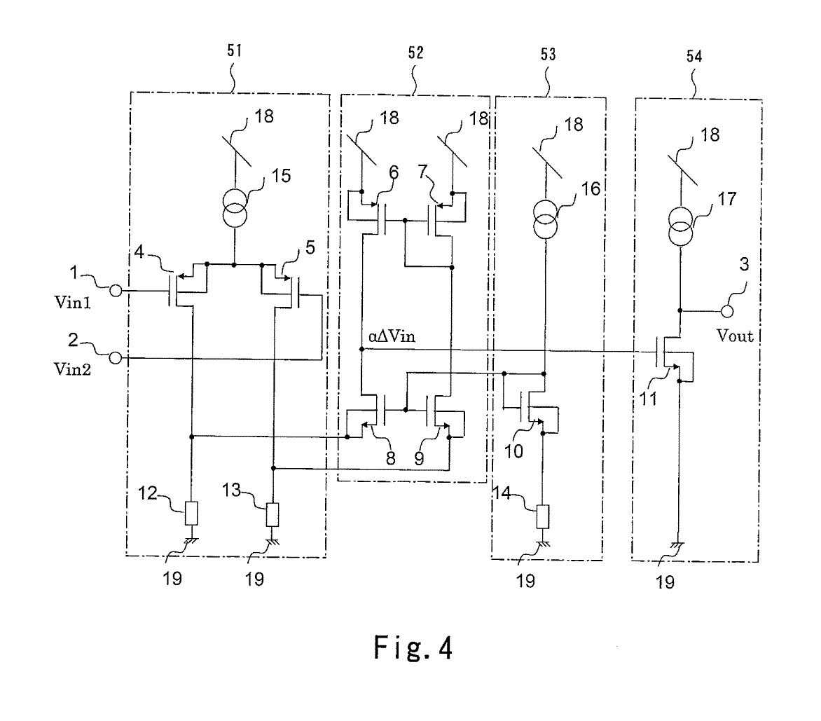

FIG. 4 is a circuit diagram showing an example of the configuration of the operational amplifier in the condenser-microphone amplifying device of FIG. 1.

As shown in FIG. 4, the operational amplifier 20 comprises, for example, a differential amplifying unit 51 which differentially amplifies a pair of input voltages Vin1 and Vin2 corresponding to a differential input ΔVin; a differential outputting unit 52 which outputs a differential αΔVin between a pair of output voltages from the differential amplifying unit 51; a gate voltage setting unit 53 by which the transistors forming the differential outputting unit 52 are operated in the active region; and an outputting unit 54 which amplifies the output αΔVin of the differential outputting unit 52 and then outputs it from the output terminal 3.

In the differential amplifying unit 51, a first current source 15 is connected to a power supply 18; the source of a first P-channel MOS transistor 4 is connected to the first current source 15; one of the ends of a first resistor 12 is connected to the drain of the first P-channel MOS transistor 4; and the other of the ends of the first resistor 12 is connected to a grounding terminal. In addition, the source of a second P-channel MOS transistor 5 is connected, in parallel with the first P-channel MOS transistor 4, to the first current supply 15; one of the ends of a second resistor 13 is connected to the drain of the second P-channel MOS transistor 5; and the other of the ends of the second resistor 13 is connected to a grounding terminal. And the gate of the first P-channel MOS transistor 4 is connected to the inverting input terminal 1, and the gate of the second P-channel MOS transistor 5 is connected to the non-inverting input terminal 2.

In the differential outputting unit 52, the source of a third P-channel MOS transistors 6 is connected to a power supply 18; the drain of a first N-channel MOS transistor 8 is connected to the drain of the third P-channel MOS transistor 6; and the source of the first N-channel MOS transistor 8 is connected to a node where the first resistor 12 of the differential amplifying unit 51 and the drain of the first P-channel MOS transistor 4 are joined. In addition, the source of a fourth P-channel MOS transistor 7 is connected to a power supply 18; the drain of a second N-channel MOS transistor 9 is connected to the drain of the fourth P-channel MOS transistor 7; and the source of the second N-channel MOS transistor 9 is connected to a node where the second resistor 13 of the differential amplifying unit 51 and the drain of the second P-channel MOS transistor 5 are joined. The gate of the third P-channel MOS transistor 4 and the gate of the fourth P-channel MOS transistor 5 are connected together and the gate of the fourth P-channel MOS transistor 5 is connected to the drain of the aforementioned P-channel MOS transistor 5. That is, the P-channel MOS transistor 5 is diode-connected. The gate of the first N-channel MOS transistor 8 and the gate of the second N-channel MOS transistor 9 are connected together and in addition, are connected to the gate voltage setting unit 53.

In the gate voltage setting unit 53, a second current source 16 is connected to a power supply 18; the drain of a third N-channel MOS transistor 10 is connected to the second current source 16; one of the ends of a third resistor 14 is connected to the source of the third N-channel MOS transistor 10; and the other of the ends of the third resistor 14 is connected to a grounding terminal. The third N-channel MOS transistor 10 is diode-connected, and the gate of the third N-channel MOS transistor 10 is connected to both of the gates of the first and second N-channel MOS transistors 8 and 9 of the differential outputting unit 52.

In the outputting unit 54, a third current source 17 is connected to a power supply 18; the drain of a fourth N-channel MOS transistor 11 is connected to the third current source 17; and the source of the fourth N-channel MOS transistor 11 is connected to a grounding terminal. The gate of the fourth N-channel MOS transistor 11 is connected to a node where the drain of the third P-channel MOS transistor 6 of the differential outputting part and the drain of the first N-channel MOS transistor 8 of the differential outputting part are joined. And, Connected to the output terminal 3 is a node where the third current source 17 and the drain of the fourth N-channel MOS transistor 11 are joined.

Next, a brief description will be given in regard to the operation of the operational amplifier 20 configured as above. In the gate voltage setting unit 53, a current determined by the current of the third current source 16 and the resistive value of the third resistor 14 is converted, by the diode-connected, third N-channel MOS transistor 10, into a constant voltage that is then applied to both of the gates of the first and the second N-channel MOS transistors 8 and 9. This constant voltage is set so that these transistors operate in the active region.

In this state, when the input voltage Vin1 is input to the non-inverting input terminal 1 and the input voltage Vin2 is input to the inverting input terminal 2, this causes the outputting of a voltage, decreased from the constant bias voltage by the amount of a voltage proportional to the differential input ΔVin, to a node where the first resistor 12 and the drain of the first P-channel MOS transistor 4 are joined in the differential amplifying unit 51, and also causes the outputting of a voltage, increased from the constant bias voltage by the amount of a voltage proportional to the differential input ΔVin, to a node of the second resistor 13 and the drain of the second P-channel MOS transistor 5 are joined in the differential amplifying unit 51.

Because of the operation of the first N-channel MOS transistor 8 and the operation of the second N-channel MOS transistor 9, currents according, respectively, to a pair of output voltages from the differential amplifying unit 51 flow, respectively, through two current pathways of the differential outputting circuit 52. However, the current determined by the operation of the second N-channel MOS transistor 9 is converted by the diode-connected, fourth P-channel MOS transistor 7 into a voltage that is then applied to the gate of the third P-channel MOS transistor 6. Thereby, the current determined by the operation of the first N-channel MOS transistor 8 is diminished by the operation of the third P-channel MOS transistor 6. Thereby, a differential between the pair of the output voltages from the differential amplifying unit 51, αΔVin, is fed to a node where the first N-channel MOS transistor 8 and the third P-channel MOS transistor 6 are joined.

This differential αΔVin is further amplified by the fourth N-channel MOS transistor 11 of the outputting unit 54 and is output as a differential amplified output voltage Vout from the output terminal 3.

### Operation

Next, a description will be given in regard to the operation of the condenser-microphone amplifying device having the above-described configuration.

First, its normal operation will be described. Referring to FIG. 1, during normal operation, the ESD protecting element does not become conductive, and a sound pressure signal from the ECM 21 is inverted and amplified by the operational amplifier 20 and then, is output from the output terminal 3. If in this case, the capacity of the ECM is represented as C1 and the capacity of the capacitor 24 is represented as C2, the gain G of the amplifying device is equal to C1/C2 in the case where the resistance value of the resistive element 23 is sufficiently large.

Next, a description will be given in regard to the operation in the case where electrostatic discharge occurs.

Referring to FIGS. 1, 3 and 4, if electrostatic discharge occurs, for example, to the inverting input terminal 1 during assembly of the condenser-microphone amplifying device, the ESD protecting element 25 becomes conductive. Because of this, there is formed a route for escape of the electrostatic discharge which extends from the inverting input terminal 1 to the power supply terminal 18 or to the grounding terminal 19 by way of the ESD protecting element 25, whereby any voltage in excess of the withstand voltages is not applied to the first P-channel MOS transistor 4 of the operational amplifier 20, to the resistive element 23 and to the capacitor 24. Therefore, the first P-channel MOS transistor 4 of the operational amplifier 20, the resistive element 23 and the capacitor 24 will not undergo breakdown.

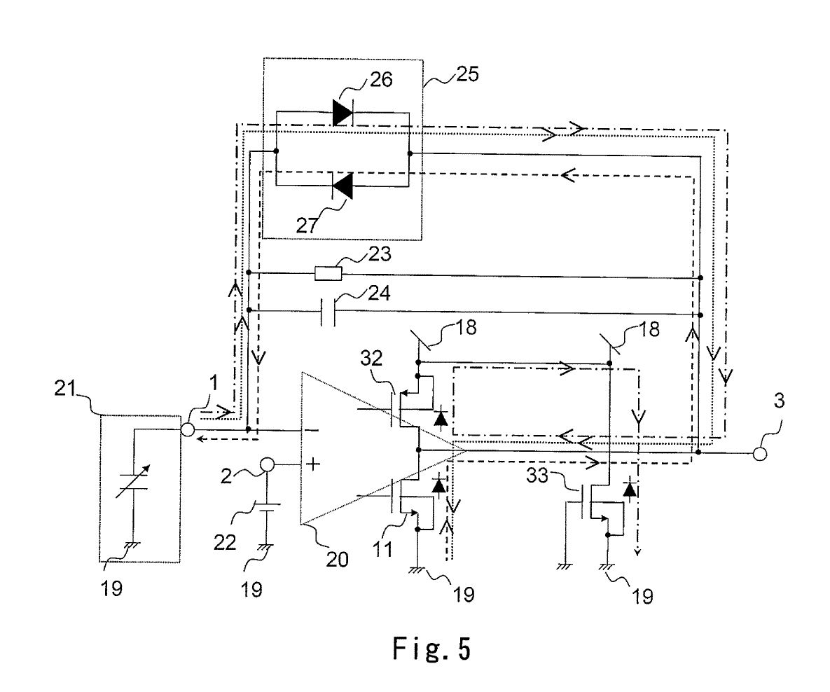

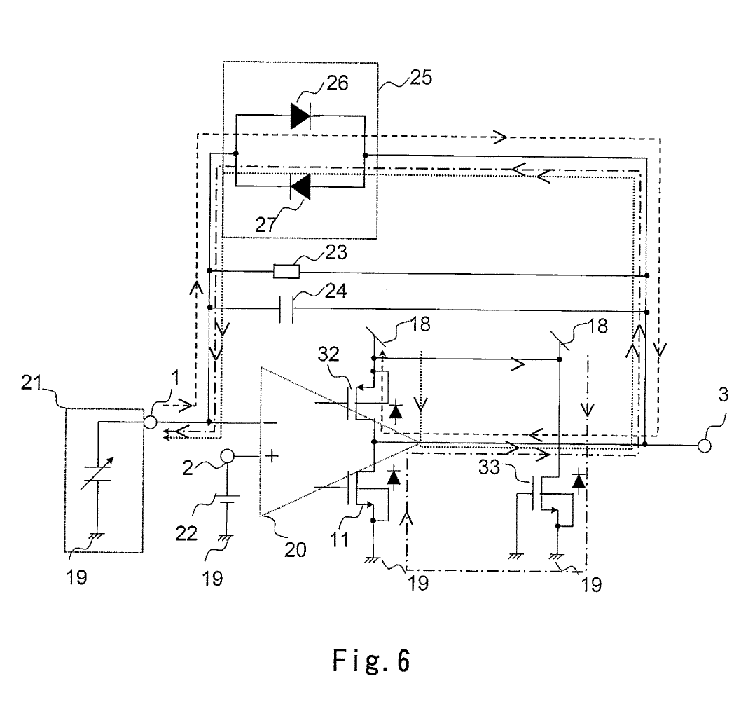

Hereinafter, referring to FIGS. 5 and 6, current emission routes in the case where electrostatic discharge occurs to the inverting input terminal 1 will be described in regard to the case on the basis of the grounding terminal 19 and the case on the basis of the power supply terminal 18.

FIGS. 5 and 6 show equivalent circuits of FIGS. 1 and 4, and are diagrams showing current emission routes in the case where electrostatic discharge occurs to the inverting input terminal 1 in the condenser-microphone amplifying device shown in FIG. 1. Referring to FIGS. 5 and 6, there are shown internal elements connected to the output terminal 3 of the operational amplifier 20 for clear identification of the current emission routes. Connected to the output terminal 3 of the operational amplifier 20 are the drain of the fourth N-channel MOS transistor 11 and the third current source 17. The third current source 17 is constituted, as one example of the current source circuit, by a current mirror and is shown by a fifth P-channel MOS transistor 32.

FIG. 5 shows surge current emission routes in the case on the basis of the grounding terminal 19, and FIG. 6 shows surge current emission routes in the case on the basis of the power supply terminal 18. Referring to FIGS. 5 and 6, there is shown an N-channel MOS transistor 33 serving as an external terminal ESD protecting element connected between the power supply terminal 18 not shown in FIG. 1 and the grounding terminal 19. Such an external terminal ESD protecting element is generally disposed in integrated circuits. In addition, in FIGS. 5 and 6, there is shown an example case where the ESD protecting element 25 is constituted by a pair of diodes 26 and 27 and in addition, with respect to each of the MOS transistors 11, 32 and 33, their diode elements are noted using a diode representing symbol for easy understanding.

### Case Based On Grounding Terminal

If on the basis of the grounding terminal 19, a plus surge voltage is applied to the inverting input terminal 1, a current by the surge voltage flows from the inverting input terminal 1, through the ESD protecting element 25 and then through the fifth P-channel MOS transistor 32 (the third current source 17) of the operational amplifier 20, to the grounding terminal 19 because of the breaking down of the N-channel transistor 33 (the exterior terminal ESD protecting element) connected between the power supply terminal 18 and the grounding terminal 19, as indicated by alternate long and short dash line in FIG. 5. Here, the N-channel transistor 33 is not destructed because the breaking down of the N-channel transistor 33 is a pn-junction reversible breakdown due to backward voltage. This is different from non-reversible destruction of the isolation (the gate insulating film) between the gate, and either the source or the drain. The non-reversible destruction occurs in the case where a surge voltage is applied to the first P-channel MOS transistor 4 forming an input part from the inverting input terminal 1 of the operational amplifier 20.

In addition, in the case where a plus surge voltage is applied to the inverting input terminal 1, it is likely that a current by the surge voltage flows from the inverting input terminal 1, through the ESD protecting element 25, to the grounding terminal 19 because of the breaking down of the fourth N-channel MOS transistor 11 of the operational amplifier 20, as indicated by dotted line in FIG. 5.

On the other hand, in the case where on the basis of the grounding terminal 19, a minus surge voltage is applied to the inverting input terminal 1, a current by the surge voltage flows from the grounding terminal 19, through the fourth N-channel MOS transistor 11 of the operational amplifier 20 and then through the ESD protecting element 25, to the inverting input terminal 1, as indicated by broken line in FIG. 5.

### Case Based On Power Supply Terminal

In the case where on the basis of the power supply terminal 18, a plus surge voltage is applied to the inverting input terminal 1, a current by the surge voltage flows from the inverting input terminal 1, through the ESD protecting element 25 and then through the fifth P-channel MOS transistor 32 of the operational amplifier 20, to the power supply terminal 18, as indicated by broken line in FIG. 6. On the other hand, in the case where on the basis of the power supply terminal 18, a minus surge voltage is applied to the inverting input terminal 1, a current by the surge voltage flows from the power supply terminal 18, through the fourth N-channel MOS transistor 11 of the operational amplifier 20 and then through the ESD protecting element 25, to the inverting input terminal 1 because of the breaking down of the N-channel transistor 33 connected between the power supply terminal 18 and the grounding terminal 19, as indicated by alternate long and short dash line in FIG. 6. In addition, in the case where on the basis of the power supply terminal 18, a minus surge voltage is applied to the inverting input terminal 1, it is likely that a current by the surge voltage flows from the power supply terminal 18, through the ESD protecting element 25, to the inverting input terminal 1 because of the breaking down of the fifth P-channel MOS transistor 32 of the operational amplifier 20, as indicated by dotted line in FIG. 6.

As has been described above, according to the first embodiment, the input impedance is set at from several GΩ to several tens of GΩ so that to a desired electric characteristic is met and in addition, the ESD tolerance is improved. As a result, neither special handling nor special control is required in the manufacture, whereby the manufacture lead time can be reduced and in addition, it becomes possible to intend to cut down the costs.

In addition, since the ESD tolerance depends on the allowable current value of the ESD protecting element 25, it is accordingly preferable to set the size of the ESD protecting element 25, depending on the element characteristic, so that the input impedance ranges from several GΩ to several tens of GΩ and in addition, the ESD tolerance becomes one free from special handling and special control in the manufacture.

In addition, in the foregoing description making reference to FIG. 5 and FIG. 6, there is exemplarily shown, as a current route when a surge voltage is applied, a current route that passes through an internal element of the operational amplifier 20 (the fourth N-channel MOS transistor 11 or the fifth P-channel MOS transistor 32). However, it suffices that the current route, when a surge voltage is applied, includes at least a pathway extending through the ESD protecting element 25 to the output terminal 3 of the operational amplifier 20 and for example, an additional ESD protecting element may be connected between the output terminal 3 of the operational amplifier 20 and the power supply terminal 18 or between the output terminal 3 of the operational amplifier 20 and the grounding terminal 19. Also in this case, the input impedance of the condenser-microphone amplifying device will not be reduced, whereby a desired electric characteristic can be met and in addition, the ESD tolerance can be improved.

### Second Embodiment

FIG. 7 is a circuit diagram showing the configuration of a condenser-microphone amplifying device according to a second embodiment of the present invention.

As shown in FIG. 7, in the condenser-microphone amplifying device of the second embodiment, the ESD protecting element 25 is constituted by a pair of diode-connected, N-channel MOS transistors 28 and 29, other than which the condenser-microphone amplifying device of the second embodiment is the same as the condenser-microphone amplifying device of the first embodiment.

More specifically, the ESD protecting element 25 is constituted by the pair of the N-channel MOS transistors 28 and 29 wherein the drain of the one N-channel MOS transistor 28 and the source of the other N-channel MOS transistor 29 are connected together while on the other hand, the source of the one N-channel MOS transistor 28 and the drain of the other N-channel MOS transistor 29 are connected together. Each of the N-channel MOS transistors 28 and 29 is formed into a drain-gate connected “diode connection”. Even when employing such a configuration, the same effects as the first embodiment can be accomplished.

In addition, as a substitute for the one pair of the N-channel MOS transistors 28 and 29, a pair of P-channel MOS transistors may be used, and it is needless to say that a combination of a single N-channel MOS transistor and a single P-channel MOS transistor may be employed.0

### Third Embodiment

FIG. 8 is a circuit diagram showing the configuration of a condenser-microphone amplifying device according to a third embodiment of the present invention.

As shown in FIG. 8, in the condenser-microphone amplifying device of the third embodiment, the ESD protecting element 25 is constituted by a pair of diode-connected npn bipolar transistors 30 and 31, other than which the condenser-microphone amplifying device of the third embodiment is the same as the condenser-microphone amplifying device of the first embodiment.

More specifically, the ESD protecting element 25 is constituted by the pair of the NPN bipolar transistors 30 and 31 wherein the collector of the one NPN bipolar transistor 30 and the emitter of the other NPN bipolar transistor 31 are connected together while on the other hand, the emitter of the one NPN bipolar transistor 30 and the collector of the other NPN bipolar transistor 31 are connected together. Each of the NPN bipolar transistors 30 and 31 is Formed into a collector-base connected “diode connection”. In such a configuration, also, the same effects as the first embodiment can be accomplished.

In addition, as a substitute for the one pair of the NPN bipolar transistors 30 and 31, a pair of PNP bipolar transistors may be used, and it is needless to say that a combination of a single NPN bipolar transistor and a single PNP bipolar transistor may be employed.

### Fourth Embodiment

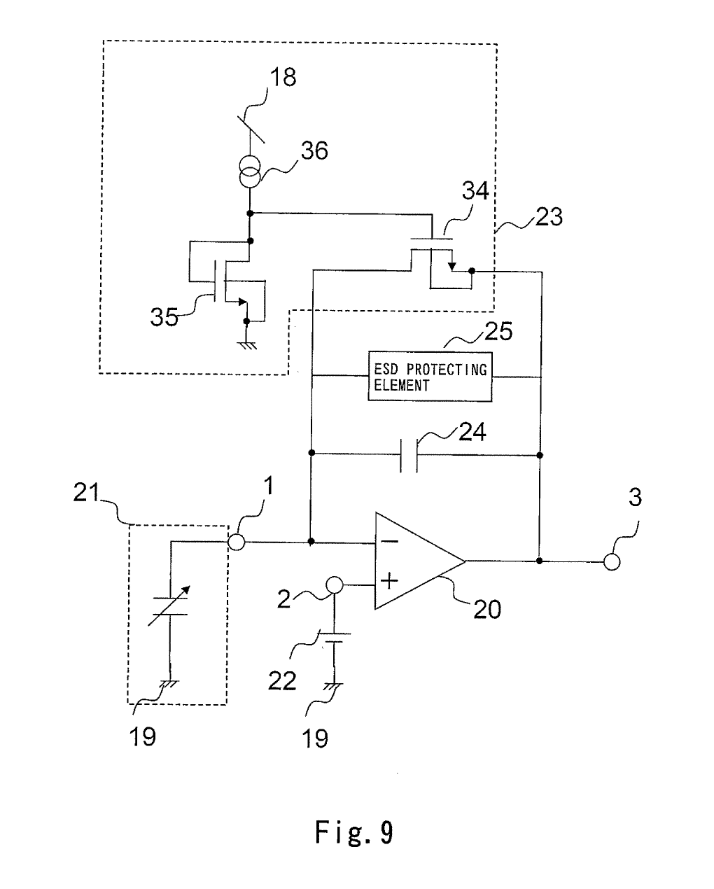

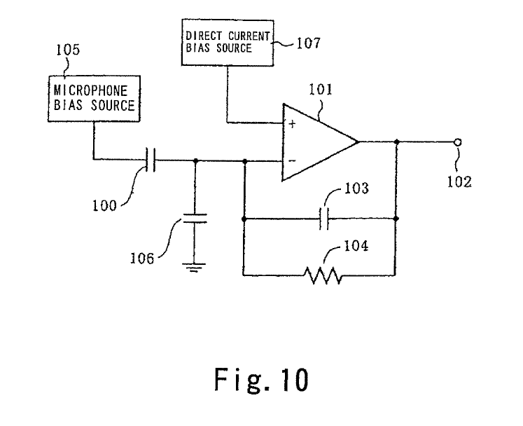

FIG. 9 is a circuit diagram showing the configuration of a condenser-microphone amplifying device according to a fourth embodiment of the present invention.

As shown in FIG. 9, in the condenser-microphone amplifying device of the fourth embodiment, the resistive element 23 is constituted by a high resistive circuit using a transistor 34 or the like, other than which the condenser-microphone amplifying device of the fourth embodiment is the same as the condenser-microphone amplifying device of the first embodiment.

More specifically, for example, the resistive element 23 is provided with a seventh N-channel MOS transistor 34, an eighth N-channel MOS transistor 35 and a fourth current source 36.

The gate of the seventh N-channel MOS transistor 34 is fed with a gate-source voltage VGS corresponding to the on voltage of the diode-connected, eighth N-channel MOS transistor 35 connected to the fourth current source 36. Because of this, the seventh N-channel MOS transistor 34 operates in an on state, i.e., in a strong inversion region. When the current (drain current) of the seventh N-channel MOS transistor 34 is nearly zero, the seventh N-channel MOS transistor 34 operates in a non-saturation region (triode region).

The current, Itri, in the non-saturation region is represented by the following expression (see, for example, “Design of Analog CMOS Integrated Circuit, p 17: by Behzad Razavi, McGRAW-HILL),

Itri=k·(W1/L1)·((VGS1−VTH)·VDS1−VDS1²/2),

where k is the current amplification factor that can be expressed by a product of the mobility μ and the MOS transistor's gate capacity (Cox), W is the gate width and L is the gate length. VTH is the threshold voltage and VDS is the drain-source voltage.

If the current Itri is differentiated with respect to the drain-source voltage VDS to take the reciprocal thereof, this results in Ron (the MOS transistor's resistive value) which is represented by the following expression:

Ron=L1/(k·W1·(VGS1−VDS1−VTH))

With the configuration shown in FIG. 9, when the current of the seventh N-channel MOS transistor 34 is nearly zero, the drain-source voltage likewise becomes nearly zero (VDS1≈0 V). The current amplification factor k is the value that is determined from the semiconductor process and is designed by selection of the gate-source voltage VGS, the gate width W and the gate length L so as to result in a desired resistance value.

In addition, FIG. 9 shows that each of the transistors is constituted by an N-channel MOS transistor, but they each may be constituted by a P-channel MOS transistor. Additionally, a plurality of the seventh N-channel MOS transistors 34 may be connected in series. In this case, it becomes possible to obtain a higher resistance value.

In accordance with the fourth embodiment, by causing the seventh N-channel MOS transistor 34 to operate in a non-saturation region as described above, it becomes possible to provide a configuration that has a smaller chip area and a higher resistance value as compared to polysilicon resistors. Because of this, although the chip area increases due to the provision of the ESD protecting element 25, its degree of increase can be reduced.

In addition, in the first embodiment and the fourth embodiment, a zener diode or an MSM diode (metal-semiconductor-metal diode) may be used as the ESD protecting element 25.

In addition, the fourth embodiment may be combined with the second embodiment or the third embodiment.

As this invention may be embodied in several forms without departing from the sprit of essential characteristics thereof, the present embodiments are therefore illustrative and not restrictive, since the scope of the invention is defined by the appended claims rather than by the description proceeding them, and all changes that fall within metes and bounds of the claims, or equivalence of such metes and bounds thereof are therefore intended to be embraced by the claims.

### INDUSTRIAL APPLICABILITY

The microphone amplifying device of the present invention finds useful applications in small portable equipment for portable phones as an amplifying device which is capable of setting of the input impedance at from several GΩ to several tens of GΩ and which is improved in ESD tolerance.

### REFERENCE SIGNS LIST

### 1 INVERTING INPUT TERMINAL

### 2 NON-INVERTING INPUT TERMINAL

### 3 OUTPUT TERMINAL

### 4 FIRST P-CHANNEL MOS TRANSISTOR

### 5 SECOND P-CHANNEL MOS TRANSISTOR

### 6 THIRD P-CHANNEL MOS TRANSISTOR

### 7 FOURTH P-CHANNEL MOS TRANSISTOR

### 8 FIRST N-CHANNEL MOS TRANSISTOR

### 9 SECOND N-CHANNEL MOS TRANSISTOR

### 10 THIRD N-CHANNEL MOS TRANSISTOR

### 11 FOURTH N-CHANNEL MOS TRANSISTOR

### 12 FIRST RESISTOR

### 13 SECOND RESISTOR

### 14 THIRD RESISTOR

### 15 FIRST CURRENT SOURCE

### 16 SECOND CURRENT SOURCE

### 17 THIRD CURRENT SOURCE

### 18 POWER SUPPLY TERMINAL

### 19 GROUNDING TERMINAL

### 20 OPERATIONAL AMPLIFIER

### 21 CONDENSER MICROPHONE (ECM)

### 22 DC BIAS POWER SUPPLY

### 23 RESISTIVE ELEMENT

### 24 CAPACITOR

### 25 ESD PROTECTING ELEMENT

### 26 DIODE

### 27 DIODE

### 28 N-CHANNEL MOS TRANSISTOR

### 29 N-CHANNEL MOS TRANSISTOR

### 30 NPN BIPOLAR TRANSISTOR

### 31 NPN BIPOLAR TRANSISTOR

### 32 FIFTH P-CHANNEL MOS TRANSISTOR

### 33 N-CHANNEL MOS TRANSISTOR AS EXTERNAL ESD PROTECTING ELEMENT

### 34 SEVENTH N-CHANNEL MOS TRANSISTOR

### 35 EIGHTH N-CHANNEL MOS TRANSISTOR

### 36 FOURTH CURRENT SOURCE

### 51 DIFFERENTIAL AMPLIFYING UNIT

### 52 DIFFERENTIAL OUTPUTTING UNIT

### 53 GATE VOLTAGE SETTING UNIT

54 OUTPUTTING UNIT

1. An amplifying device for a condenser microphone, said condenser-microphone amplifying device comprising:
a differential amplifier having an inverting input terminal to which a sound pressure signal output from said condenser microphone is input and a non-inverting input terminal to which a dc bias voltage is applied;
a capacitor connected between an output terminal of said differential amplifier and said inverting input terminal of said differential amplifier;
a resistive element connected, in parallel with said capacitor, between said output terminal of said differential amplifier and said inverting input terminal of said differential amplifier; and
an ESD protecting element having bidirectional diode characteristics, said ESD protecting element being connected, in parallel with said capacitor, between said output terminal of said differential amplifier and said inverting input terminal of said differential amplifier.

2. The amplifying device for the condenser microphone as set forth in claim 1, wherein said ESD protecting element is constituted by a pair of diodes which are connected so as to be opposite with each other in a conduction direction of ON-current.

3. The amplifying device for the condenser microphone as set forth in claim 1 wherein said ESD protecting element is constituted by a pair of MOS transistors which are each diode-connected and which are connected so as to be opposite with each other in a conduction direction of ON-current.

4. The amplifying device for the condenser microphone as set forth in claim 1 wherein said ESD protecting element is constituted by a pair of bipolar transistors which are each diode-connected and which are connected so as to be opposite with each other in a conduction direction of ON-current.

5. The amplifying device for the condenser microphone as set forth in claim 1 wherein said differential amplifier is an operational amplifier.

6. The amplifying device for the condenser microphone as set forth in claim 1 wherein said differential amplifier is configured using a MOS transistor as an amplifying element.

7. The amplifying device for the condenser microphone as set forth in claim 1 wherein said condenser microphone is an electret condenser microphone.

8. The amplifying device for the condenser microphone as set forth in claim 1 wherein said condenser microphone is an MEMS microphone.

9. The amplifying device for the condenser microphone as set forth in claim 1 wherein an additional ESD protecting element is connected between the output terminal of the differential amplifier and a power supply terminal or between the output terminal of the differential amplifier and a grounding terminal.
